(19) United States
(12) Patent Application Publication
(10) Pub. No.: US 2008/0281827 A1
(43) Pub. Date: Nov. 13, 2008

(54) USING STRUCTURED DATABASE FOR WEBPAGE INFORMATION EXTRACTION

(75) Inventors: Ye-Yi Wang, Redmond, WA (US); Alejandro Acero, Bellevue, WA (US); Mandar A. Rahurkar, Urbana, IL (US)

Correspondence Address: WESTMAN CHAMPLIN (MICROSOFT CORPORATION), SUITE 1400, 900 SECOND AVENUE SOUTH, MINNEAPOLIS, MN, 55402-3244, US

(73) Assignee: Microsoft Corporation, Redmond, WA (US)

(21) Appl. No.: 11/746,790

(22) Filed: May 10, 2007

(51) Int. Cl. G06F 17/30

(52) U.S. Cl. 707/10; 707/E17.044

(57) ABSTRACT

A structured database is used for webpage information extraction, and in particular, to obtain training data from the webpage for training a statistical model. The structured database has a plurality of entries, wherein each entry comprises a plurality of fields. One of the fields comprises a URL (uniform resource locater), while another field comprises information at least similar to other information to be located in a webpage associated with the URL. For at least some of the entries in the structured database, a web page associated with the URL is retrieved. The webpage is analyzed and if information is found in the webpage similar to the information in the structured database, the webpage is identified as being suitable to be considered as a training sample.

### BACKGROUND

The discussion below is merely provided for general background information and is not intended to be used as an aid in determining the scope of the claimed subject matter.

The World Wide Web is a large and growing source of information. Many have attempted to extract various information from it and put in the form of a structured database. Named entity recognition (NER) (also known as entity identification (EI) and entity extraction) is a form of information extraction. This process attempts to obtain elements from the text of a webpage and place it into predefined categories such as the names of persons, organizations, addresses, phone numbers, expressions of times, quantities, monetary values, percentages, etc. Once classified, this information might be used for a higher level task. For example, structured databases can be automatically generated by identifying entities like business names, addresses and telephone numbers from website information.

Although the information can be quite useful, obtaining accurate information is difficult. Many NER systems depend on annotated data used to train the system; and thus, NER systems are as good as the data used to train them. More importantly, obtaining sufficient training data takes time and can be labor intensive. Current NER techniques range from using regular expressions to finite-state sequence models and have achieved varying degrees of success.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

A structured database is used for webpage information extraction, and in particular, to obtain training data from the webpage for training a statistical model. The structured database has a plurality of entries, wherein each entry comprises a plurality of fields. One of the fields comprises a URL (uniform resource locater), while another field comprises information at least similar to other information to be located in a webpage associated with the URL. For at least some of the entries in the structured database, a webpage associated with the URL and possibly its descendant pages within a specific depth are retrieved. The webpages are analyzed and if information is found in one of the webpages similar to the information in the structured database, the webpage is identified as being suitable to be considered as a training sample.

The webpages are particularly useful as training samples to obtain values related to markup language features when the second information is rendered. Such features include but are not limited to portions of the URL and features related to the font, size and color changes, location in the DOM tree, surrounding context and the HTML tags around the second information when rendered. The features and corresponding values can be used to train statistical models that can later be used to find similar “second information” in webpages of other websites.

In one embodiment, similarity of the first information and the second information is based on calculating a score for each text block of a webpage (a node in its DOM tree) and using the scores to rank the blocks, where those blocks having a suitably high enough score are identified, and together with the features around them, they are used as training examples. In one embodiment, the score can be based on calculating an “edit distance” between the first information and the second information. Generally, an “edit distance” between two patterns A and B is defined as the minimum number of changes (insertion, substitution or deletion) that have to be done to the first one in order to obtain the second one.

### BRIEF DESCRIPTION OF THE DRAWINGS

FIG. 1 is schematic diagram of a webpage processing system.

FIG. 2 is a pictorial representation of a portion of a structured database.

FIG. 3A and 3B are flow chart diagrams demonstrating steps associated with obtaining training data from a webpage using the structured database.

FIG. 4 is a schematic representation of a DOM document.

FIG. 5 illustrates an example of a computing system environment.

### DETAILED DESCRIPTION

One aspect herein described is to use webpage contextual information (e.g. information related to a markup language such as but not limited to Hypertext Markup Language, “HTML”, which is used herein as an example) associated with other information on the webpage such as information concerning a named entity, for example, a business entity, as input features for training a statistical model. Once trained, the statistical model can then be used to find the desired information from further webpages. Examples of contextual information include portions of the Universal Resource Locater (“URL”) of the webpage such as the URL base name or the last part of the URL. Other contextual information includes the surrounding text content and the surrounding HTML tags that relate to the font, color and size of the text to name just a few. However, to build such a model, training data is needed; and if such training data could be obtained automatically with little user interaction that would be particularly advantageous.

A second aspect herein described is collecting the training data, and in particular, using a structured database having examples that can be used. In the illustrative embodiment, information pertaining to named entities is used. In particular, a business and its associated website as available in the structured database are used by way of example. Nevertheless, it should be understood this is but one example and that the techniques herein described and claimed should not be limited to business named entities, or even named entities in general, but rather, these techniques can be used to obtain other information including other types of named entities that may be found on webpages.

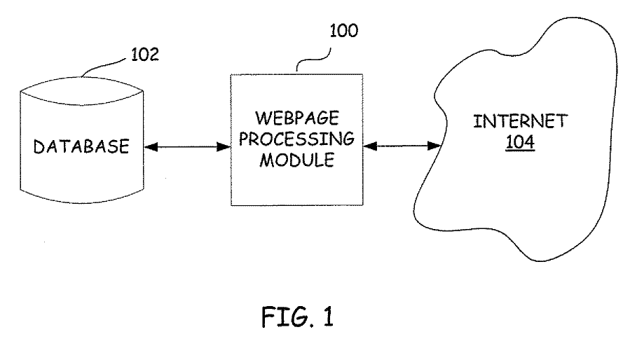

FIG. 1 illustrates a webpage processing module 100 that uses entries in a structured database 102 in combination with accessing webpages identified therein from the World Wide Web (Internet) 104 to locate a webpage having the information. The module 100 then processes the webpage to obtain data suitable for training. In the illustrative embodiment, the entries are named entities comprising businesses and the information concerns additional information about the business such as its address, phone number, etc.

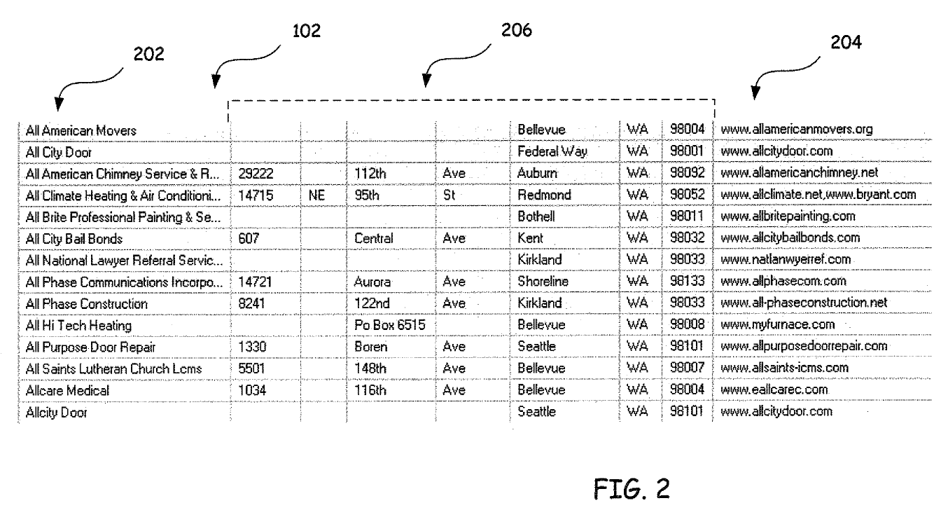

FIG. 2 illustrates a portion of structured database 102 in the exemplary embodiment of FIG. 1 In one embodiment, structured database 102 is either a publicly available database or proprietary database, and in this example includes thousands of business locations with their URL's and address entities. However, not all these entries can be used for obtaining the features for the structured information. For instance, even with the URL present, the website may be under repair or dysfunctional. Furthermore, some businesses may be using flash or non-text (e.g., Image Maps) related navigational methods, and hence, crawling these webpages does not yield useful information. The foregoing illustrates that the structured database 102 need not be perfect, but rather, instead can be imperfect and need only be large enough with complete or partially complete entries to provide sufficient data to train a statistical model as discussed below.

As indicated above, in the illustrative example, structured database 102 contains the name 202 of the business, the URL 204 of the business, and one or more tokens (elements) of the address 206. Consider now a business location address A is composed of string tokens A₁ . . . Aₙ with its corresponding URL U (typically for the root or home webpage). The problem now is to find the entity A′ on the corresponding webpage for the URL U or one of its ‘k’ outlinks (lower or “child” webpages) U₁ . . . Uₖ such that it maximizes a similarity metric, discussed later, with A. Let D_{U}_{ᵢ}^{j} be the jth node in the Document Object Model (DOM) tree of the Uᵢth document. This problem is treated as ranking the nodes (each text block of a webpage) D_{U}_{ᵢ}^{j} of the Document Object Model (DOM) tree for all ‘i’. From the information retrieval perspective, A can be thought of as the query, while DOM of U and U₁ . . . Uₙ, as the collection of indexed documents.

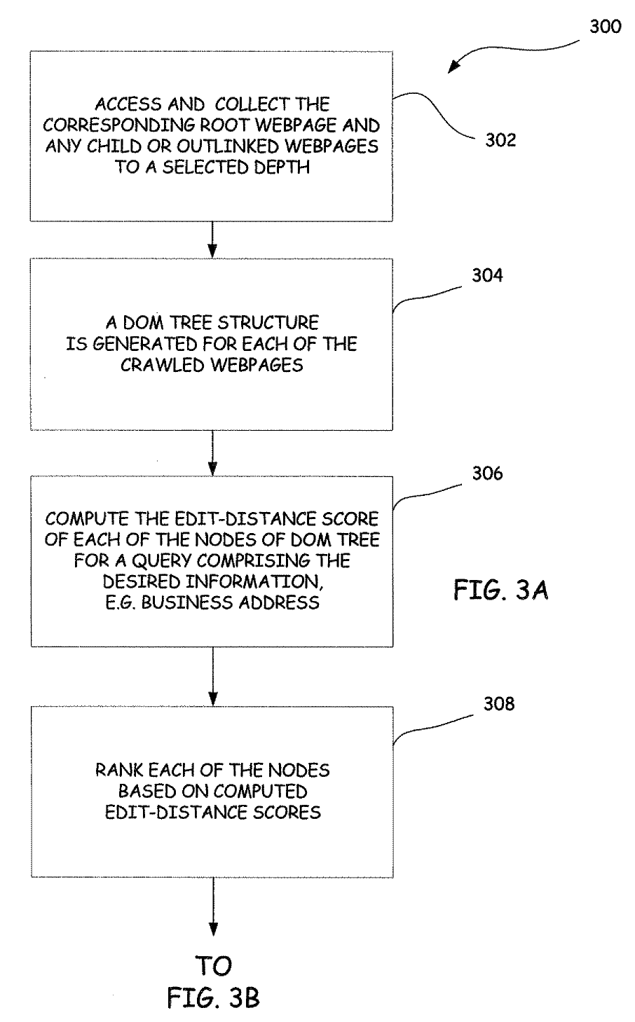

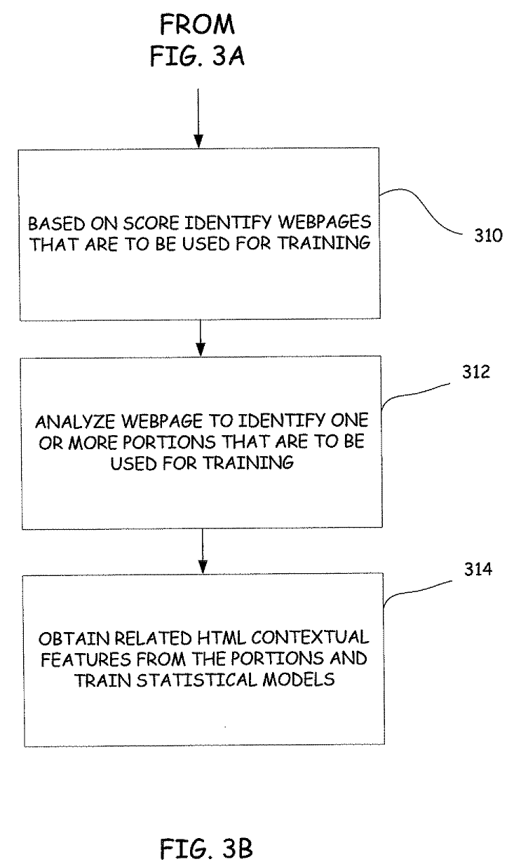

A method 300, illustrated in FIG. 3A, illustrates in general using an entry to obtain and process corresponding webpages for the associated URL U.

The webpage processing module 100 progresses through entries of database 102 until a suitable entry is located in this case having a useable address A. At step 302, The URL for the entry having A is accessed in order to collect the corresponding root webpage and any child or outlinked webpages to a selected depth. Progressing father into the website is done since the entity A might not be present on the main URL. Deeper inspection/collection of the website can be done but inspection/collection (i.e. crawling) to a depth of two levels may be a suitable compromise between size of the corpus and the precision of the algorithm.

At step 304, a DOM tree structure is generated for each of the crawled webpages in step 302.

At step 306, with A considered as the query/reference, a score indicative of the similarity of information on the webpage and the query is computed for each of the nodes of the DOM tree. In one embodiment, an edit-distance score is calculated; however other scores using methods to compare similarity can be used. Steps 302, 306 and 308 are performed for as many entries in database 102 so as to realize a sufficient amount of training data.

At step 308, the DOM nodes D_{U}_{ᵢ}^{j} are ranked using the proposed scoring function to assess which ones contain the best matches. Those with scores above a particular threshold will be processed (FIG. 3B).

Generally, an “edit distance” between two patterns A and B is defined as the minimum number of changes (insertion, substitution or deletion) that have to be done to the first one in order to obtain the second one. If the associated insertion and deletion costs are same, edit distance can be symmetric. Herein the similarity between each string(s) in the node D_{U}_{ᵢ}^{j} and A is computed using a modified version of the dynamic programming algorithm for edit-distance calculation (Wagner and M. Fischer. “The String-to-String Correction Problem” Journal of Association for Computing Machinery. 1974).

Below is an example for two patterns, reference pattern containing six tokens and test pattern from a particular node in a DOM tree. The move of digit 1, starting at the upper left cell in the table illustrates a match or different types of errors: a horizontal move represents a deletion error, a vertical move represents a insertion error, and a diagonal move represents either a match or a substitution error, depending on the equality of the reference word at the same column and the test word at the same row of the table cell that the move reaches.
Reference String: 14721 Aurora Avenue North Shoreline Wash. 98133
Test String: . . . 14721 Aurora Ave Shoreline Wash. 98133 . . .

| | | | | | Shore- | | |
|---|---|---|---|---|---|---|---|
| . . . | 14721 | Aurora | Avenue | North | line | WA | 98133 |
| 14721 | 1 | 0 | 0 | 0 | 0 | 0 | 0 |
| Aurora | 0 | 1 | 1 | 0 | 0 | 0 | 0 |
| Ave | 0 | 0 | 0 | 1 | 0 | 0 | 0 |
| Shoreline | 0 | 0 | 0 | 0 | 1 | 0 | 0 |
| WA | 0 | 0 | 0 | 0 | 0 | 1 | 0 |
| 98133 | 0 | 0 | 0 | 0 | 0 | 0 | 1 |

Though at first glance this might seem to be an optimal solution, two problems exist. The first problem arises due to the nature of edit distance metric. Consider the following test pattern for the reference string:
Reference String: “ACL Conf.”

| Test Patterns | Edit Distance |
|---|---|
| 1 - “ACL Conf. held in Prague” | 3 |
| 2 - “Prague” | 2 |

Although the second test pattern has a lower edit distance “2”, the first pattern is a closer match. In particular, for the test pattern three string tokens “held”, “in” and “Prague” need to deleted to obtain the reference string, whereas for the second test pattern one substitution of “ACL” for “Prague” and one insertion “Conf.” equates to the edit distance of 2. It is clear that the first test pattern is a better match even though the edit distance of the second test pattern is less than that the first test pattern.

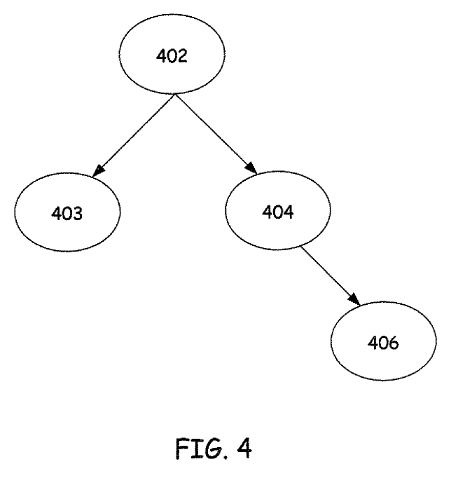

Another problem arises due to the structure of the DOM tree itself, where all child node tokens are also part of their respective parent tokens as shown in the FIG. 4. Thus, if a particular leaf/child node 406 contains the entity, all the nodes 402, 404 at higher hierarchical levels would also return a hit. The task is to find the most compact node which has the complete (or as much as possible) entity since tokens of an entity might be spread across several nodes. A ranking scheme is proposed to address this problem. In order to isolate the relevant string sequence from the clutter in the DOM, the method backtraces the path, and the edit distance of a particular node is re-computed from the last match of the first term in the reference string and the first match of the last term in the reference string Let |x| be the no of tokens in x or cardinality of x. Two measures are provided, normalized Match Ratio (NMR) and Normalized Order Ratio NOR) as:

$$NMR = \frac{\vert Matches \vert}{\vert ReferenceEntity \vert}$$

$$NOR = \frac{\vert Matches \vert}{\vert TestNode \vert}$$

Both these measures can be understood intuitively. NMR looks at the number of matches of tokens in a reference string sequence with that of tokens in test string sequence. Ideally, the NMR would be one. Clutter in a particular node, i.e., number of non-entity tokens, is reflected by NOR. If a particular node has a lot of nonentity string tokens, the denominator increases. Thus NOR is inversely proportional to clutter in a particular node. These measures address the problems mentioned previously. In one embodiment, the goal is to rank order all the DOM tree nodes based on a function of their NMR and NOR scores. A simple ranking function can represented as:

$$RF = NMR + NOR$$

$$RF = \frac{\vert Matches \vert}{\vert ReferenceEntity \vert} + \frac{\vert Matches \vert}{\vert TestNode \vert}$$

Further insight of these measures can be found by examining their bounds. Worst case matching scenario for any node is |matches|=0 occurs when none of the tokens A₁ . . . Aₙ are found in that particular DOM tree node. Hence the lower bound for the measures, NMR as well as NOR will be zero. The upper bound for NMR will happen when the entire test string is matched with tokens in the reference string. The bounds can be summarized as follows:

$$0 \leq NMR \leq \frac{\vert TestNode \vert}{\vert ReferenceEntity \vert}$$

$$0 \leq NOR \leq 1$$

$$0 \leq RF \leq 1 + \frac{\vert TestNode \vert}{\vert ReferenceEntity \vert}$$

Since the RF scores are computed at the granularity of each node, it is practically unlikely in case of address entity, that any tokens in reference string will be repeated. Hence for all practical purposes the bounds on RF scores can be considered to be:

0≦RF≦2

Referring now to FIG. 3B, and with the webpage scores compiled and ranked, step 310 includes identifying those webpages having a sufficiently high score to obtain training data from, i.e., webpages that contain-sufficiently high matches for that listed in database 102 versus that found on a webpage. It should be therefore understood that the RF score reflects that the information in the database 102 need not be a perfect match with what is found in the website.

At step 312, each webpage is then analyzed to ascertain one or more portions that can be used for training. In one embodiment, this includes using conditional random fields (CRF's) to sequentially label the words in the running text that have been identified as corresponding to the information in the database 102. If desired, boolean values (e.g. “IN”, “OUT”) can be used, where IN indicates that the word is part of the named entity information, while OUT indicates the opposite.

At step 314, with the webpage labeled, values for selected HTML related contextual features surrounding the information can be obtained, whereupon after sufficient feature data has been obtained from all webpages, the statistical model can be then trained. If desired, statistical gradient descent or perceptron training algorithm can be used to speed up learning for scalability.

Although the HTML contextual features that may be indicative of the information desired from a webpage depends in large part on the type of information being sought, some of the HTML contextual features that have been shown to be indicative of finding information, and in particular, information related to business named entities will be discussed.

One of the features that can be used in the statistical model is the base name of the webpage having the desired information. Again, using the exemplary embodiment of ascertaining address information related to a business entity, the base name of the webpage having the address information from the training data is recorded. For instance, it is quite common that web developers use similar base names for the webpage having the business address. Some examples include:
“find.html” as in “www.allaundry.com/find.html”
“contact.html” as in “www.pizzashop.com/contact.html”
“contact_us.html” as in www.springfieldgolf.com/contact_us.html

In addition to the name of the webpage that the desired information resides on, other HTML contextual information that can be indicative of the desired information includes a font size, a font change in size between portions of the information such as the business name and its address. Likewise, a certain color, or simply that fact that a color change commonly occurs between the business name and address may also be a feature used to determine the desired information.

The foregoing can be used alone or in combination with other non-HTML contextual features. For instance, another useful features may be the words used (i.e. word based features). For instance, words like “Inc”, “Company” etc. may be indicative of the business name, while words like “street”, “avenue”, “road” etc. are commonly found in addresses. Similarly, a list of city and state names can be used, where if a city or state from the list is found it can be indicative of that portion of the webpage having the address of the business. Also, the pattern of the characters can be indicative. For example, two letters followed by five digits (as is commonly found in state and zipcode designations), can be a characteristic feature that can be used to identify that that portion of the webpage contains the desired information.

Other word based features include the surrounding text of a DOM tree node. For example,

“Phone” in “Phone: 425 555-1212” or

“US Mail” in “US Mail: 123 Main Street NY N.Y.”

is indicative of an upcoming phone number or address.

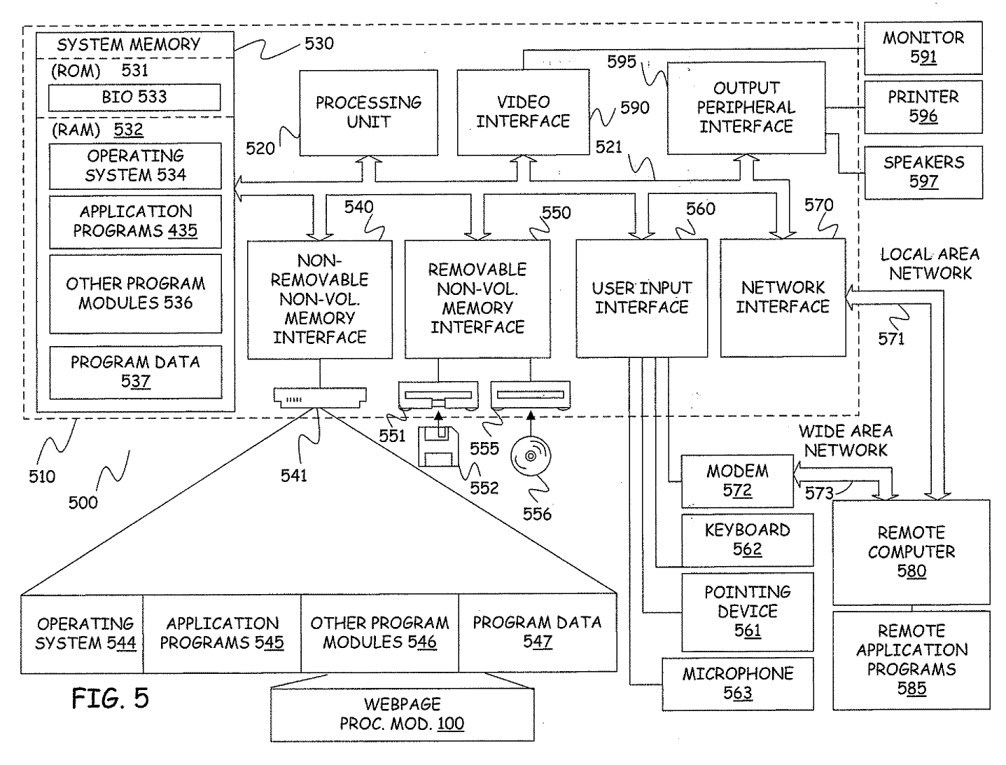

FIG. 5 illustrates an example of a suitable computing system environment 500 in which embodiments may be implemented. The computing system environment 500 is only one example of a suitable computing environment and is not intended to suggest any limitation as to the scope of use or functionality of the claimed subject matter. Neither should the computing environment 500 be interpreted as having any dependency or requirement relating to any one or combination of components illustrated in the exemplary operating environment 500.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The concepts herein described may be embodied in the general context of computer-executable instructions, such as program modules, being executed by a computer. Generally, program modules include routines, programs, objects, components, data structures, etc. that perform particular tasks or implement particular abstract data types. Those skilled in the art can implement the description and/or figures herein as computer-executable instructions, which can be embodied on any form of computer readable media discussed below.

With reference to FIG. 5, an exemplary system for implementing some embodiments includes a general-purpose computing device in the form of a computer 510. Components of computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA. (ESA) bus, Video EIectronics Standards Association (VESA) local bus, and Peripheral Component Interconnect (PCI) bus also known as Mezzanine bus.

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 510+Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The computer 510 may also include other removable/non-removable volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives, and their associated computer storage media discussed above and illustrated in FIG. 5, provide storage of computer readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. It can be seen that FIG. 5 shows webpage processing module 100 residing in other applications 546. Of course, it will be appreciated that module 100 can reside in other places as well, including in the remote computer, or at any other location that is desired.

A user may enter commands and information into the computer 510 through input devices such as a keyboard 562, a microphone 563, and a pointing device 561, such as a mouse, trackball or touch pad. Other input devices (not shown) may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. In addition to the monitor, computers may also include other peripheral output devices such as speakers 597 and printer 596, which may be connected through an output peripheral interface 595.

The computer 510 is operated in a networked environment using logical connections to one or more remote computers, such as: a remote computer 580. The remote computer 580 may be a personal computer, a hand-held device, a server, a router, a network PC; a peer device or other common network node, and typically includes many of all of the elements described above relative to the computer 510. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof may be stored in the remote memory storage device. By way of example, and not limitation, FIG. 5 illustrates remote application programs 585 as residing on remote computer 580. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above as has been determined by the courts. Rather, the specific features and acts described above are disclosed as example forms of implementing the claims.

1. A computer-implemented method of obtaining webpage training samples, the method comprising:
accessing a structured database having a plurality of entries, wherein each entry comprises a plurality of fields, one of the fields comprising a URL (uniform resource locater) and another one of the fields comprising first information at least similar to second information to be located in a webpage associated with the URL; and
for each of the plurality of entries in the structured database, retrieving a webpage associated with the URL; and
analyzing the webpage to find the second information therein corresponding to the first information in the structured database, and if the second information is found in the webpage storing information indicative of the webpage as a training sample.

2. The computer-implemented method of claim 1 wherein retrieving the webpage associated with the URL includes retrieving a root webpage associated with the URL.

3. The computer-implemented method of claim 2 wherein retrieving the webpage associated with the URL includes retrieving a plurality of webpages of varying hierarchy associated with the URL.

4. The computer-implemented method of claim 3 and further comprising generating a document object model (DOM) for each of the webpages.

5. The computer-implemented method of claim 4 wherein a score is calculated indicative of similarity of the first information with the second information.

6. The computer-implemented method of claim 5 wherein the score is based on an edit-distance between the first information and the second information.

7. The computer-implemented method of claim 6 wherein the score is based on a number of matches of tokens in the second information with that of tokens in the first information relative to a number of tokens in the first information, and the number of matches of tokens in the second information with that of tokens in the first information relative to a number of tokens in the second information.

8. The computer-implemented method of claim 5 and further comprising analyzing the webpages having a score above a selected threshold indicating close correspondence between the first information and the second information so as to obtain values of markup language related features pertaining to the second information.

9. The computer-implemented method of claim 8 wherein one of the markup language features comprises the last portion of the URL.

10. The computer-implemented method of claim 8 wherein the markup language features relates to at least one of size, font and color of the second information when rendered.

11. The computer-implemented method of claim 8 and further comprising analyzing surrounding text of the second information to obtain values of markup language related features pertaining to the second information.

12. A computer-implemented method of obtaining webpage training samples, the method comprising:
accessing a structured database having a plurality of entries, wherein each entry comprises a plurality of fields, one of the fields comprising a URL (uniform resource locater) and another one of the fields comprising first information at least similar to second information to be located in a webpage associated with the URL; and
for each of the plurality of entries in the structured database, retrieving a webpage associated with the URL; and
analyzing the webpage to obtain an indication of the similarity of the second information therein with the first information in the structured database, and if the indication indicates substantial correspondence analyzing the webpage so as to obtain values of markup language related features pertaining to the second information.

13. The computer-implemented method of claim 12 wherein one of the markup language features comprises the last portion of the URL.

14. The computer-implemented method of claim 12 wherein the markup language features relates to a size of the second information when rendered.

15. The computer-implemented method of claim 12 wherein the markup language features relates to a font of the second information when rendered.

16. The computer-implemented method of claim 12 wherein the markup language features relates to a color of the second information when rendered.

17. The computer-implemented method of claim 12 and further comprising analyzing surrounding text of the second information to obtain values of markup language related features pertaining to the second information.

18. A system for obtaining webpage training samples, the system comprising:
a structured database having a first plurality of entries and a second plurality of entries, wherein each entry of the first plurality of entries and the second plurality of entries comprises a plurality of fields, one of the fields comprising a URL (uniform resource locater) and another one of the fields in the first plurality of entries comprises first information at least similar to second information to be located in a webpage associated with the URL, and wherein said another one of the fields in the second plurality of entries lacks information;
a webpage processing module configured to operate with the structured database and access the Internet, the webpage processing module configured to retrieve a webpage associated with the URL for each entry of only the first plurality of entries in the database and not the second plurality of entries, configured to obtain a score for each webpage retrieved and rank the webpages based on the score.

19. The system of claim 18 wherein the score is based on an edit-distance between the first information and the second information.

20. The system of claim 19 wherein the score is based on a number of matches of tokens in the second information with that of tokens in the first information relative to a number of tokens in the first information, and the number of matches of tokens in the second information with that of tokens in the first information relative to a number of tokens in the second information.
